(19) United States
(12) Patent Application Publication
(10) Pub. No.: US 2007/0079072 A1
(43) Pub. Date: Apr. 5, 2007

(54) Preemptive eviction of cache lines from a directory

(76) Inventors: Josh D. Collier, Royersford, PA (US); Joseph S. Schibinger, Phoenixville, PA (US); Craig R. Church, Wayne, PA (US)

Correspondence Address: Unisys Corporation;Attn: Richard Gregson, Unisys Way, MS/E8-114, Blue Bell, PA, 19424-0001, US

(21) Appl. No.: 11/540,277

(22) Filed: Sep. 29, 2006

Related U.S. Application Data
(60) Provisional application No. 60/722,623, filed on Sep. 30, 2005.
(60) Provisional application No. 60/722,317, filed on Sep. 30, 2005.
(60) Provisional application No. 60/722,633, filed on Sep. 30, 2005.
(60) Provisional application No. 60/722,092, filed on Sep. 30, 2005.

(51) Int. Cl. G06F 12/00

(52) U.S. Cl. 711/133

(57) ABSTRACT

A directory for maintaining cache line entries may include a limited amount of space for the entries. A preemptive eviction of an entry of the directory is performed so that adequate space for a new entry may be created. The eviction may be performed when a system is in a low-activity state or an idle state in order to conserve system resources. Such a state may also ensure that the new entry does not have to wait to be entered into the directory. The eviction may include the examination of entries to determine if the contents may be eliminated from the directory. The system may establish certain criteria to aid in this determination. Once evicted from the directory, any modified data associated with the entry is transferred to a memory location.

### REFERENCE TO RELATED APPLICATIONS

This application claims benefit under 35 U.S.C. § 119(e) of provisional U.S. Pat. Ser. Nos. 60/722,092, 60/722,317, 60/722,623, and 60/722,633 all filed on Sep. 30, 2005, the disclosures of which are incorporated herein by reference in their entirely.

The following commonly assigned co-pending applications have some subject matter in common with the current application:

U.S. application Ser. No. 11/______ filed Sep. 29, 2006, entitled “Providing Cache Coherency in an Extended Multiple Processor Environment”, attorney docket number TN426, which is incorporated herein by reference in its entirety;

U.S. application Ser. No. 11/______ filed Sep. 29, 2006, entitled “Tracking Cache Coherency In An Extended Multiple Processor Environment”, attorney docket number TN428, which is incorporated herein by reference in its entirety; and

U.S. application Ser. No. 11/______ filed Sep. 29, 2006, entitled “Dynamic Presence Vector Scaling in a Coherency Directory”, attorney docket number TN422, which is incorporated herein by reference in its entirety.

### FIELD OF THE INVENTION

The current invention relates generally to data processing systems and more particularly to a preemptive eviction of cache lines in a directory.

### BACKGROUND OF THE INVENTION

Multi-processor-based computing systems in many implementations utilize data caching memory structures to increase processing efficiencies. These multi-processor computing systems may also used shared memory structures to permit cooperative processing to occur between processing tasks executing within two or more of these processors. Problems may arise in computing systems that implement a combination of these memory structures that relates to data coherency as multiple processors access and/or modify the data

Data caching memory structures attempt to increase processing efficiencies by permitting a block of data, typically called a cache line, to be stored within memory, such as a processor's local memory, that has shorter access times when the data is being used by a processing task. The cache line may correspond to a copy of a block of data that is stored elsewhere within the address space of the processing system. The cache line may be copied into a processor's local memory when it is needed and may be discarded when the processing task no longer needs the data. Data caching structures may be implemented for systems that used a distributed memory organization in which the address space for the system is divided into blocks that are also used as local memory for all of the processors within the multi-processor system. Data caching structures may also be implemented for systems that use a centralized memory organization in which the memory's address space corresponds to a large block of centralized memory.

Because a particular block of memory corresponding to a cache line within cache memory associated with more than one processor regardless of system memory organization and because one or more of these processors utilizing this particular cache line may desire to modify the data stored within its cache line, cache coherency processes are typically used to permit the modification of data under controlled conditions while permitting the prior propagation of any modifications to the contents of a cache line to all other copies of that cache line within the multi-processor computing system. Typically, the cache coherency processes use directory structures to maintain information regarding the cache lines currently in used by a particular processor.

Directory structures may maintain state and location information of multiple cache lines in a multi-processor computer system that includes multiple caches. A full directory maintains entries for every cache line of the system, while a sparse directory keeps entries for a limited, predetermined number of cache lines. Thus, a sparse directory contains only a limited number of locations in which to store the cache line information. When the directory is full and a new entry needs to be included in the directory, it is necessary to evict an existing entry. The eviction may include a transfer of the evicted cache line data back to memory in cases in which the contents of the cache line have been modified. The eviction, however, may utilize valuable processing resources as at least one transaction is implemented to perform the eviction while the new entry is waiting to be entered. A more desirable option would allow the eviction of entries, in order to make available space in the directory, while the system is in an idle or low-activity level. Such an option would allow a new directory entry to be made quickly and without slowing the system. In addition, cache-to-cache transfers, which incur high latencies when providing requested data, would be reduced as more modified cache line entries would be located back in memory following the modifications.

### SUMMARY OF THE INVENTION

A preemptive eviction of an entry of a directory is performed to create adequate space for a new entry. The eviction may be performed when a system is in a low-activity state or an idle state in order to conserve system resources.

The eviction includes the examination of entries to determine if the contents may be eliminated from the directory. The system may establish certain criteria to aid in this determination. Oldest entries or least-recently used entries may be chosen for eviction. Once evicted from the directory, the entry may be transferred to a memory location.

This Summary of the Invention is provided to introduce a selection of concepts in a simplified form that are further described below in the Detailed Description of Illustrative Embodiments. This Summary of the Invention is not intended to identify key features or essential features of the claimed subject matter, nor is it intended to be used to limit the scope of the claimed subject matter.

### BRIEF DESCRIPTION OF THE DRAWINGS

The foregoing summary and the following detailed description of the invention are better understood when read in conjunction with the appended drawings. Exemplary embodiments of the invention are shown in the drawings, however it is understood that the invention is not limited to the specific methods and instrumentalities depicted therein. In the drawings:

FIG. 1a is a block diagram of a shared multiprocessor system;

FIG. 1b is a logical block diagram of a multiprocessor system according to an example embodiment of the present invention;

FIG. 1c illustrates a block diagram of a multi-processor system having two cells depicting interconnection of two System Controller (SC) and multiple Coherency Directors (CDs) according to an embodiment of the present invention.

FIG. 1d depicts aspects of the cell to cell communications according to an embodiment of the present invention.

FIG. 2 is a diagram of an example directory according to an embodiment;

FIG. 3 is a block diagram of an example preemptive cache line eviction system according to an embodiment;

FIG. 4 is a block diagram of an example preemptive eviction monitor according to an embodiment;

FIG. 5 is a flow diagram of an example preemptive cache line eviction method according to an embodiment; and

FIG. 6 is a flow diagram of an example preemptive cache line eviction method according to an additional embodiment.

### DETAILED DESCRIPTION OF ILLUSTRATIVE EMBODIMENTS

Shared Microprocessor System

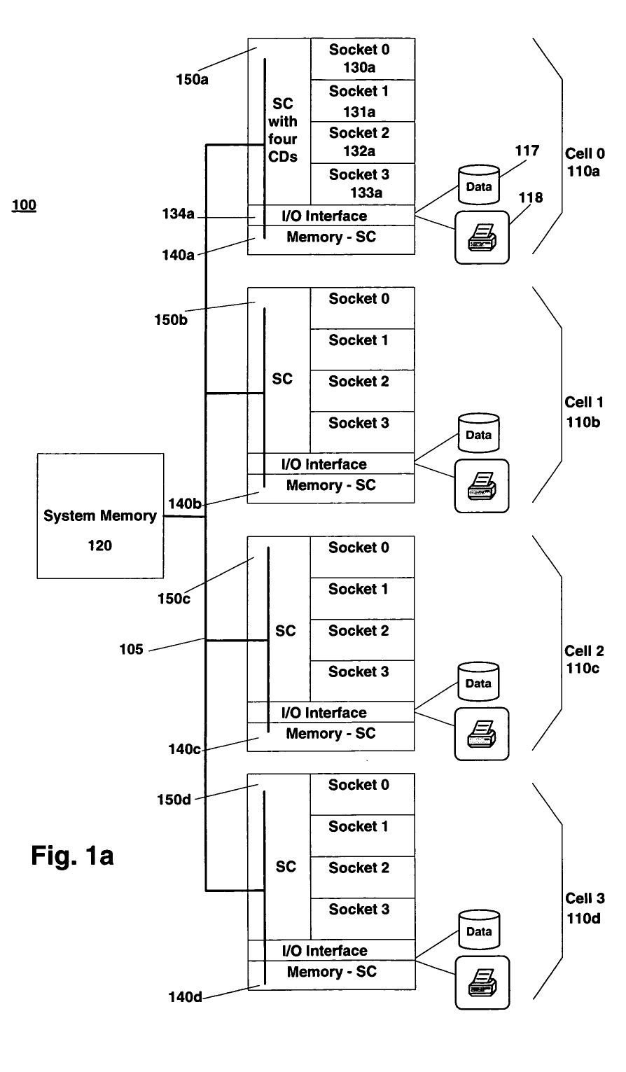

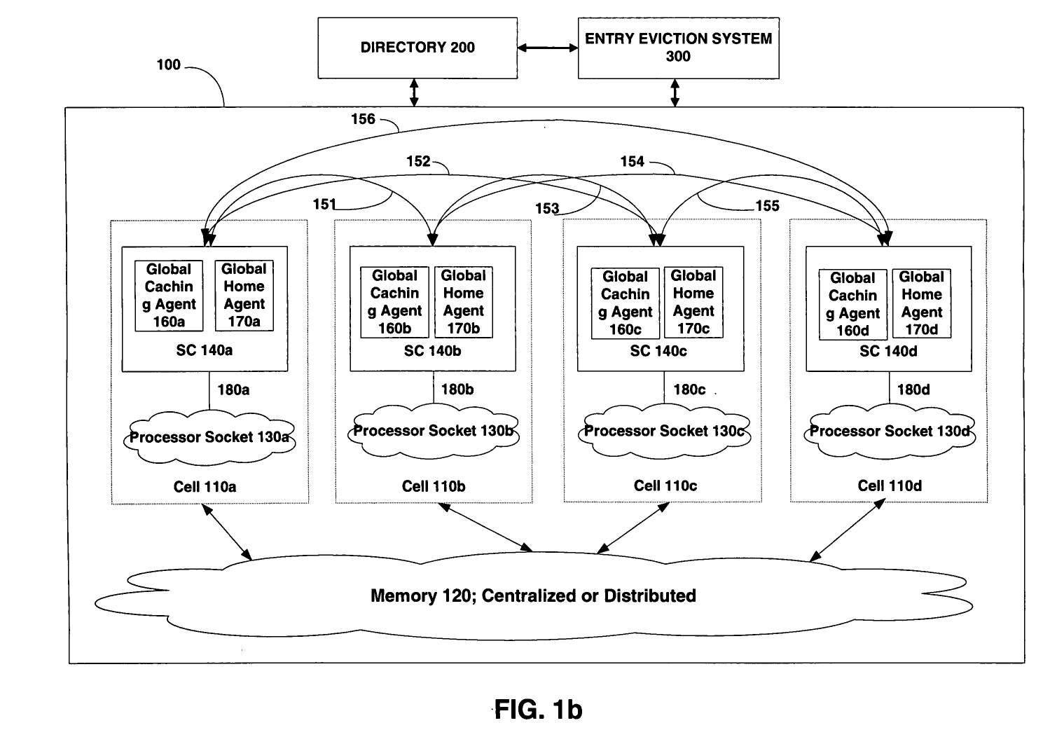

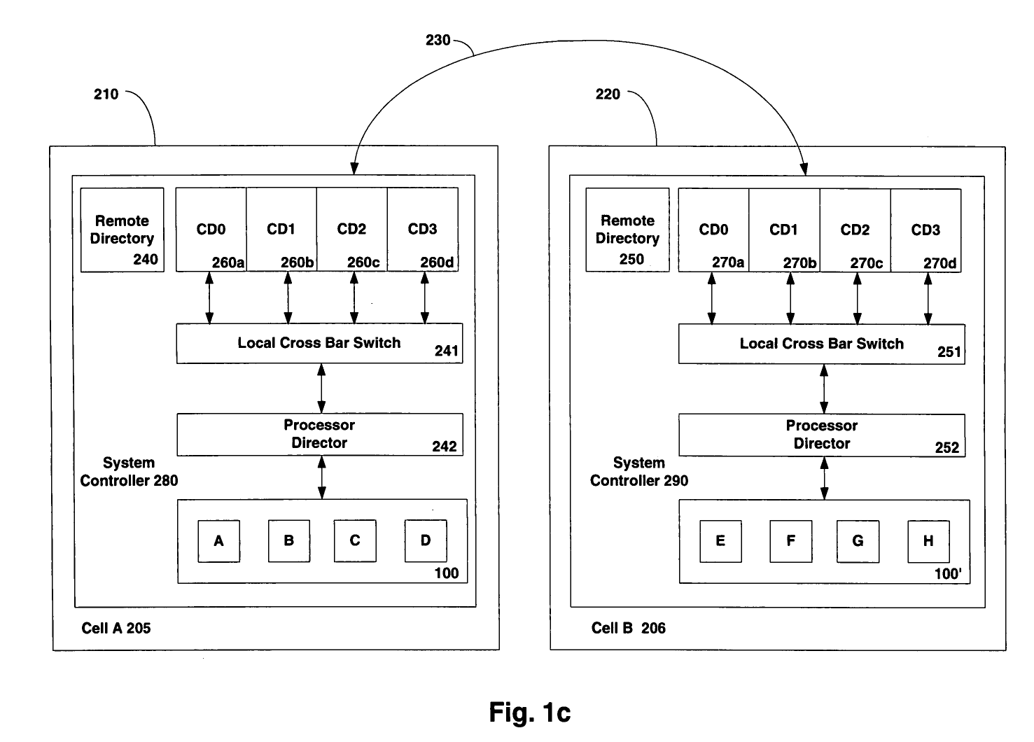

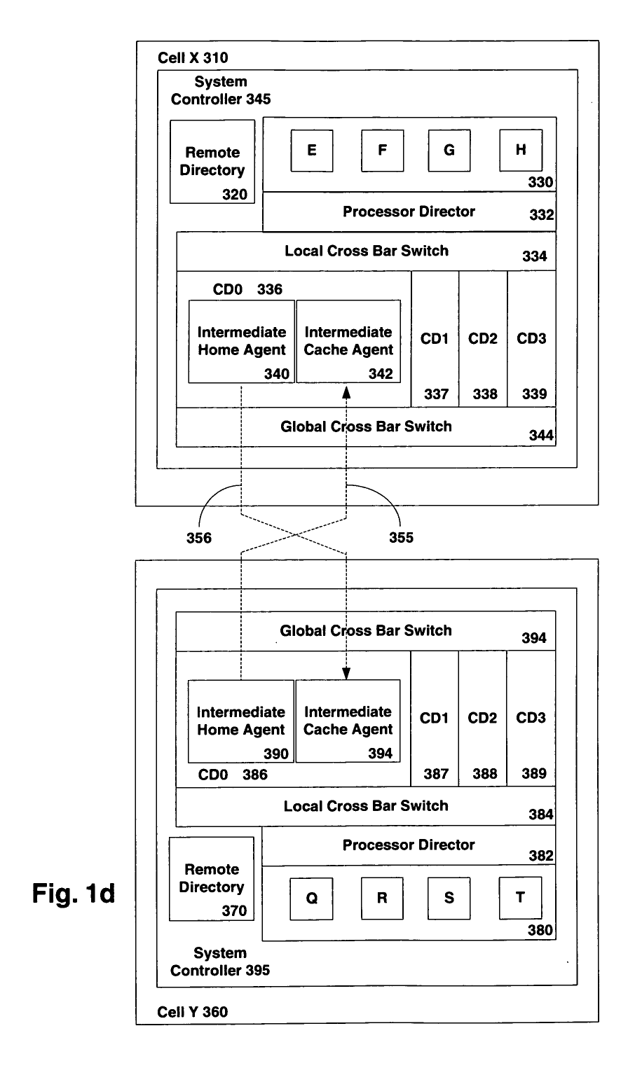

FIG. 1a is a block diagram of a shared multiprocessor system (SMP) 100. In this example, a system is constructed from a set of cells 110a-110d that are connected together via a high-speed data bus 105. Also connected to the bus 105 is a system memory module 120. In alternate embodiments (not shown), high-speed data bus 105 may also be implemented using a set of point-to-point serial connections between modules within each cell 110a-110d, a set of point-to-point serial connections between cells 110a-110d, and a set of connections between cells 110a-110d and system memory module 120.

Within each cell, a set of sockets (socket 0 through socket 3) are present along with system memory and I/O interface modules organized with a system controller. For example, cell 0 110a includes socket 0, socket 1, socket 2, and socket 3 130a-133a, I/O interface module 134a, and memory module 140a hosted within a system controller. Each cell also contains coherency directors, such as CD 150a-150d that contains intermediate home and caching agents to extend cache sharing between cells. A socket, as in FIG. 1a, is a set of one or more processors with associated cache memory modules used to perform various processing tasks. These associated cache modules may be implemented as a single level cache memory and a multi-level cache memory structure operating together with a programmable processor. Peripheral devices 117-118 are connected to I/O interface module 134a for use by any tasks executing within system 100. All of the other cells 110b-110d within system 100 are similarly configured with multiple processors, system memory and peripheral devices. While the example shown in FIG. 1a illustrates cells 0 through cells 3 110a-110d as being similar, one of ordinary skill in the art will recognize that each cell may be individually configured to provide a desired set of processing resources as needed.

Memory modules 140a-140d provide data caching memory structures using cache lines along with directory structures and control modules. A cache line used within socket 2 132a of cell 0 110a may correspond to a copy of a block of data that is stored elsewhere within the address space of the processing system. The cache line may be copied into a processor's cache memory by the memory module 140a when it is needed by a processor of socket 2 132a. The same cache line may be discarded when the processor no longer needs the data. Data caching structures may be implemented for systems that use a distributed memory organization in which the address space for the system is divided into memory blocks that are part of the memory modules 140a-140d. Data caching structures may also be implemented for systems that use a centralized memory organization in which the memory's address space corresponds to a large block of centralized memory of a system memory block 120.

The SC 150a and memory module 140a control access to and modification of data within cache lines of its sockets 130a-133a as well as the propagation of any modifications to the contents of a cache line to all other copies of that cache line within the shared multiprocessor system 100. Memory-SC module 140a uses a directory structure (not shown) to maintain information regarding the cache lines currently in used by a particular processor of its sockets. Other SCs and memory modules 140b-140d perform similar functions for their respective sockets 130b-130d.

One of ordinary skill in the art will recognize that additional components, peripheral devices, communications interconnections and similar additional functionality may also be included within shared multiprocessor system 100 without departing from the spirit and scope of the present invention as recited within the attached claims. The embodiments of the invention described herein are implemented as logical operations in a programmable computing system having connections to a distributed network such as the Internet. System 100 can thus serve as either a stand-alone computing environment or as a server-type of networked environment. The logical operations are implemented (1) as a sequence of computer implemented steps running on a computer system and (2) as interconnected machine modules running within the computing system. This implementation is a matter of choice dependent on the performance requirements of the computing system implementing the invention. Accordingly, the logical operations making up the embodiments of the invention described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto.

FIG. 1b is a logical block diagram of an exemplary computer system that may employ aspects of the current invention. The system 100 of FIG. 1b depicts a multiprocessor system having multiple cells 110a, 110b, 110c, and 110d each with a processor assembly or socket 130a, 130b, 130c, and 130d and a SC 140a, 140b, 140c, and 140d. All of the cells 110a-d have access to memory 120. The memory 120 may be a centralized shared memory or may be a distributed shared memory. The distributed shared memory model divides memory into portions of the memory 120, and each portion is connected directly to the processor socket 130a-d or to the SC 140a-d of each cell 110a-d. The centralized memory model utilizes the entire memory as a single block. Access to the memory 120 by the cells 110a-d depends on whether the memory is centralized or distributed. If centralized, then each SC 140a-d may have a dedicated connection to memory 120 or the connection may be shared as in a bus configuration. If distributed, each processor socket 130a-d or SC 140a-d may have a memory agent (not shown) and an associated memory block or portion.

The system 100 may communicate with a directory 200 and an entry eviction system 300, and the directory 200 and the entry eviction system 300 may communicate with each other, as shown in FIG. 1b. The directory 200 may maintain information related to the cache lines of the system 100. The entry eviction system 300 may operate to create adequate space in the directory 200 for new entries. The SCs 140a-d may communicate with one another via global communication links 151-156. The global communication links are arranged such that any SC 140a-d may communicate with any other SC 140a-d over one of the global interconnection links 151-156. Each SC 140a-d may contain at least one global caching agent 160a, 160b, 160c, and 160d as well as one global home agent 170a, 170b, 170c, and 170d. For example, SC 140a contains global caching agent 160a and global home agent 170a. SCs 140b, 140c, and 140d are similarly configured. The processors 130a-d within a cell 100a-d may communicate with the SC 140a-d via local communication links 180a-d. The processors 130a-d may optionally also communicate with other processors within a cell 110a-d (not shown). In one method, the request to the SC 140a-d may be conditional on not obtaining the requested cache line locally or, using another method, the system controller (SC) may participate as a local processor peer in obtaining the requested cache line.

In system 100, caching of information useful to one or more of the processor sockets 130a-d within cells 110a-d is accommodated in a coherent fashion such that the integrity of the information stored in memory 120 is maintained. Coherency in system 100 may be defined as the management of a cache in an environment having multiple processing entities, such as cells 110a-d. Cache may be defined as local temporary storage available to a processor. Each processor, while performing its programming tasks, may request and access a line of cache. A cache line is a fixed size of data, useable by a cache, that is accessible and manageable as a unit. For example, a cache line may be some arbitrarily fixed size of bytes of memory. A cache line is the unit size upon which a cache is managed. For example, if the memory 120 is 64 MB in total size and each cache line is sized to be 64 KB, then 64 MB of memory/64 bytes cache line size=1 Meg of different cache lines.

Cache lines may have multiple states. One convention indicative of multiple cache states is called a MESI system. Here, a line of cache can be one of: modified (M), exclusive (E), shared (S), or invalid (I). Each cell 110a-d in the shared multiprocessor system 100 may have one or more cache lines in each of these different states.

An exclusive state is indicative of a condition where only one entity, such as a processor 130a-d, has a particular cache line in a read and write state. No other caching agents 160a-d may have concurrent access to this cache line. An exclusive state is indicative of a state where the caching agent 160a-d has write access to the cache line but the contents of the cache line have not been modified and are the same as memory 120. Thus, an entity, such as a processor socket 130a-d, is the only entity that has the cache line. The implication here is that if any other entity were to access the same cache line from memory 120, the line of cache from memory 120 may not have the updated data available for that particular cache line. When a socket has exclusive access, all other sockets in the system are in the invalid state for that cache line. A socket with exclusive access may modify all or part of the cache line or may silently invalidate the cache line. A socket with exclusive state will be snooped (searched and queried) when another socket attempts to gain any state other than the invalid state.

Another state of a cache line is known as the modified state. Modified indicates that the cache line is present at a socket in a modified state, and that the socket guarantees to provide the full cache line of data when snooped, or searched and queried. When a caching agent 160a-d has modified access, all other sockets in the system are in the invalid state with respect to the requested line of cache. A caching agent 160a-d with the modified state indicates the cache line has been modified and may further modify all or part of the cache line. The caching agent 160a-d may always write the whole cache line back to evict it from its cache or provide the whole cache line in a snoop, or search and query, response and, in some cases, write the cache line back to memory. A socket with the modified state will be snooped when another socket attempts to gain any state other than the invalid state. The home agent 170a-d may determine from a sparse directory that a caching agent 160a-d in a cell 110a-d has a modified state, in which case it will issue a snoop request to that cell 110a-d to gain access of the cache line. The state transitions from exclusive to modified when the cache line is modified by the caching agent 160a-d.

Another mode or state of a cache line is known as shared. As the name implies, a shared line of cache is cache information that is a read-only copy of the data. In this cache state type, multiple entities may have read this cache line out of shared memory. Additionally, if one caching agent 160a-d has the cache line shared, it is guaranteed that no other caching agent 160a-d has the cache line in a state other than shared or invalid. A caching agent 160a-d with shared state only needs to be snooped when another socket is attempting to gain exclusive access.

An invalid cache line state in the SC's directory indicates that there is no entity that has this cache line. Invalid in a caching agent's cache indicates that the cache line is not present at this entity socket. Accordingly, the cache line does not need to be snooped. In a multiprocessor environment, such as the system 100, each processor is performing separate functions and has different caching scenarios. A cache line can be invalid in any or all caches, exclusive in one cache, shared by multiple read only processes, or modified in one cache and different from what is in memory.

In system 100 of FIG. 1b, it may be assumed for simplicity that each cell 110a-d has one processor. This may not be true in some systems, but this assumption will serve to explain the basic operation. Also, it may be assumed that a cell 110a-d has within it a local store of cache where a line of cache may be stored temporarily while the processor 130a-d of the cell 110a-d is using the cache information. The local stores of cache may be a grouped local store of cache or may be a distributed local store of cache within the socket 130a-d.

If a caching agent 160a-d within a cell 110a-d seeks a cache line that is not currently resident in the local processor cache, the cell 110a-d may seek to acquire that line of cache externally. Initially, the processor request for a line of cache may be received by a home agent 170a-d. The home agent 170a-d arbitrates cache requests. If for example, there were multiple local cache stores, the home agent 170a-d would search the local stores of cache to determine if the sought line of cache is present within the socket. If the line of cache is present, the local cache store may be used. However, if the home agent 170a-d fails to find the line of cache in cache local to the cell 110a-d, then the home agent 170a-d may request the line of cache from other sources.

A number of request types and directory states are relevant. The following is an example pseudo code for an exclusive request:

IF the requesting agent wants to be able to write the cache line
(requests E status) THEN

IF directory lookup = Invalid THEN

fetch memory copy to requesting agent

ELSE IF directory = Shared THEN

send a snoop to each owner to invalidate their copies,
wait for their completion
responses, then fetch the memory copy to the requesting
agent

ELSE IF directory = Exclusive THEN

send a snoop to the owner and depending on the response
send the snoop
response data (and optionally update memory) or memory
data to the requesting
agent

ELSE IF directory = M THEN

send a snoop to the owner and send the snoop response data
to the requesting
agent (and optionally update memory).

Update the directory to E or M and the new owning caching agent.

The SC 140a-d that is attached to the local requesting agents receives either a snoop request or an original request. The snoop request is issued by the local level to the SC 140a-d when the local level has a home agent 170a-d for the cache line and therefore treats the SC 140a-d as a caching agent 160a-d that needs to be snooped. In this case the SC 140a-d is a slave to the local level—simply providing a snoop response to the local level. The local snoop request is processed by the caching agent 160a-d. The caching agent 160a-d performs a lookup of the cache line in the directory, sends global snoops to home agents 170a-d as required, waits for the responses to the global snoops, issues a snoop response to the local level, and updates the director.

The original request is issued by the local level to the SC 140a-d when the local level does not have a home agent 170a-d for the cache line and therefore treats the SC 140a-d as the home agent 170a-d for the cache line. The function of the home agent 170a-d is to control access to the cache line and to read memory when needed. The local original request is processed by the home agent 170a-d. The home agent 170a-d sends the request to the caching agent 160a-d of the cell 110a-d that contains the local home of the cache line. When the caching agent 160a-d receives the global original request, it issues the original request to the local home agent 170a-d and also processes the request as a snoop similar to the above snoop function. The caching agent 160a-d waits for the local response (home response) and sends it to the home agent 170a-d. The responses to the global snoop requests are sent directly to the requesting home agent 170a-d. The home agent 170a-d waits for the response to the global request (home response), and the global snoop responses (if any), and local snoop responses (if the SC 140a-d is also a local peer), and after resolving any conflicting requests, issues the responses to the local requester.

A directory may be used to track a current location and current state of one or more copies of a cache line within a processor's cache for all of the cache lines of a system 100. The directory may include cache line entries, indicating the state of a cache line and the ownership of the particular line. For example, if cell 110a has exclusive access to a cache line, this determination may be shown through the system's directory. In the case of a line of cache being shared, multiple cells 110a-d may have access to the shared line of cache, and the directory may accordingly indicate this shared ownership. The directory may be a full directory, where every cache line of the system is monitored, or a sparse directory, where only a selected, predetermined number of cache lines are monitored.

The information in the directory may include a number of bits for the state indication; such as one of invalid, shared, exclusive, or modified. The directory may also include a number of bits to identify the caching agent 160a-d that has exclusive or modified ownership, as well as additional bits to identify multiple caching agents 160a-d that have shared ownership of a cache line. For example, two bits may be used to identify the state, and 16 bits to identity up to 16 individual or multiple caching agents 160a-d (depending on the mode). Thus, each directory information may be 18 bits, in addition to a starting address of the requested cache line. Other directory structures are also possible.

FIG. 1c depicts a system where the multiprocessor component assembly 100 of FIG. 1a may be expanded to include other similar systems assemblies without the disadvantages of slow access times and single points of failure. FIG. 1c depicts two cells; cell A 205 and cell B 206. Each cell contains a system controller (SC) 280 and 290 respectively that contain the functionality in each cell. Each cell contains a multiprocessor component assembly, 100 and 100′ respectively. Within Cell A 205 and SC 280, a processor director 242 interfaces the specific control, timing, data, and protocol aspects of multiprocessor component assembly 100. Thus, by tailoring the processor director 242, any manufacturer of multiprocessor component assembly may be used to accommodate the construction of Cell A 205. Processor Director 242 is interconnected to a local cross bar switch 241. The local cross bar switch 241 is connected to four coherency directors (CD) labeled 260a-d. This configuration of processor director 242 and local cross bar switch 241 allow the four sockets A-D of multiprocessor component assembly 100 to interconnect to any of the CDs 260a-d. Cell B 206 is similarly constructed. Within Cell b 206 and SC 290, a processor director 252 interfaces the specific control, timing, data, and protocol aspects of multiprocessor component assembly 100′. Thus, by tailoring the processor director 252, any manufacturer of multiprocessor component assembly may be used to accommodate the construction of Cell A 206. Processor Director 252 is interconnected to a local cross bar switch 251. The local cross bar switch 251 is connected to four coherency directors (CD) labeled 270a-d. As described above, this configuration of processor director 252 and local cross bar switch 251 allow the four sockets E-H of multiprocessor component assembly 100′ to interconnect to any of the CDs 270a-d.

The coherency directors 260a-d and 270a-d function to expand component assembly 100 in Cell A 205 to be able to communicate with component assembly 100′ in Cell B 206. A coherency director (CD) allows the inter-system exchange of resources, such as cache memory, without the disadvantage of slower access times and single points of failure as mentioned before. A CD is responsible for the management of a lines of cache that extend beyond a cell. In a cell, the system controller, coherency director, remote directory, coherency director are preferably implemented in a combination of hardware, firmware, and software. In one embodiment, the above elements of a cell are each one or more application specific integrated circuits.

In one embodiment of a CD within a cell, when a request is made for a line of cache not within the component assembly 100, then the cache coherency director may contact all other cells and ascertain the status of the line of cache. As mentioned above, although this method is viable, it can slow down the overall system. An improvement can be to include a remote directory into a call, dedicated to the coherency director to act as a lookup for lines a cache.

FIG. 1c depicts a remote directory (RDIR) 240 in Cell a 205 connected to the coherency directors (CD) 260a-d. Cell B 206 has its own RDIR 250 for CDs 270a-d. The RDIR is a directory that tracks the ownership or state of cache lines whose homes are local to the cell A 205 but which are owned by remote nodes. Adding a RDIR to the architecture lessens the requirement to query all agents as to the ownership of non-local requested line of cache. In one embodiment, the RDIR may be a set associative memory. Ownership of local cache lines by local processors is not tracked in the directory. Instead, as indicated before communication queries (also known as snoops) between processor assembly sockets are used to maintain coherency of local cache lines in the local domain. In the event that all locally owned cache lines are local cache lines, then the directory would contain no entries. Otherwise, the directory contains the status or ownership information for all memory cache lines that are checked out of the local domain of the cell. In one embodiment, if the RDIR indicates a modified cache line state, then a snoop request must be sent to obtain the modified copy and depending on the request the current owner downgrades to exclusive, shared, or invalid state. If the RDIR indicates an exclusive state for a line of cache, then a snoop request must be sent to obtain a possibly modified copy and depending on the request the current owner downgrades to exclusive, shared, or invalid state. If the RDIR indicates a shared state for a requested line of cache, then a snoop request must be sent to invalidate the current owner(s) if the original request is for exclusive. In this case it the local caching agents may also have shared copies so a snoop is also sent to the local agents to invalidate the cache line. If an RDIR indicates that the requested line of cache is invalid, then a snoop request must be sent to local agents to obtain a modified copy if it exists locally and/or downgrade the current owner(s) as required by the request. In an alternate embodiment, the requesting agent can perform this retrieve and downgrade function locally using a broadcast snoop function.

If a line of cache is checked out to another cell, the requesting cell can inquire about its status via the interconnection between cells 230. In one embodiment, this interconnection is a high speed serial link with a specific protocol termed Unisys® Scalability Protocol (USP). This protocol allows one cell to interrogate another cell as to the status of a cache line.

FIG. 1d depicts the interconnection between two cells; X 310 and Y 380. Considering cell X 310, structural elements include a SC 345, a multiprocessor system 330, processor director 332, a local cross bar switch 334 connecting to the four CDs 336-339, a global cross bar switch 344 and remote directory 320. The global cross bar switch allows connection from any of the CDs 336-339 and agents within the CDs to connect to agents of CDs in other cells. CD 336 further includes an entity called an intermediate home agent (IHA) 340 and an intermediate cache agent (ICA) 342. Likewise, Cell Y 360 contains a SC 395, a multiprocessor system 380, processor director 382, a local cross bar switch 384 connecting to the four CDs 386-389, a global cross bar switch 394 and remote directory 370. The global cross bar switch allows connection from any of the CDs 386-389 and agents within the CDs to connect to agents of CDs in other cells. CD 386 further includes an entity called an intermediate home agent (IHA) 390 and an intermediate cache agent (ICA) 394.

The IHA 340 of Cell X 310 communicates to the ICA 394 of Cell Y 360 using path 356 via the global cross bar paths in 344 and 394. Likewise, the IHA 390 of Cell Y 360 communicates to the ICA 344 of Cell X 360 using path 355 via the global cross bar paths in 344 and 394. In cell X 310, IHA 340 acts as the intermediate home agent to multiprocessor assembly 330 when the home of the request is not in assembly 330 (i.e. the home is in a remote cell). From a global view point, the ICA of the cell that contains the home of the request is the global home and the IHA is viewed as the global requester. Therefore the IHA issues a request to the home ICA to obtain the desired cache line. The ICA has an RDIR that contains the status of the desired cache line. Depending on the status of the cache line and the type of request the ICA issues global requests to global owners (IHAs) and may issue the request to the local home. Here the ICA acts as a local caching agent that is making a request. The local home will respond to the ICA with data; the global caching agents (IHAs) issue snoop requests to their local domains. The snoop responses are collected and consolidated to a single snoop response which is then sent to the requesting IHA. The requesting agent collects all the (snoop and original) responses, consolidates them (including its local responses) and generates a response to its local requesting agent. Another function of the IHA is to receive global snoop requests, issue local snoop requests, collect local snoop responses, consolidate them, and issue a global snoop response to global requester.

The intermediate home and cache agents of the coherency director allow the scalability of the basic multiprocessor assembly 100 of FIG. 1a. Applying aspects of the current invention allows multiple instances of the multiprocessor system assembly to be interconnected and share in a cache coherency system. In FIG. 1d, intermediate home agents (IHAs) and intermediate cache agents (ICAs) act as intermediaries between cells to arbitrate the use of shared cache lines. System controllers 345 and 395 control logic and sequence events within cells x 310 and Y 380 respectively.

In one embodiment, the RDIR may be a set associative memory. Ownership of local cache lines by local processors is not tracked in the directory. Instead, as indicated before, communication queries (also known as snoop requests and original requests) between processor assembly sockets are used to maintain coherency of local cache lines in the local cell. In the event that all locally owned cache lines are local cache lines, then the directory would contain no entries. Otherwise, the directory contains the status or ownership information for all memory cache lines that are checked out of the local coherency domain (LCD) of the cell. In one embodiment, if the RDIR indicates a modified cache line state, then a snoop request must be sent to obtain the modified copy and depending on the request the current owner downgrades to exclusive, shared, or invalid state. If the RDIR indicates an exclusive state for a line of cache, then a snoop request must be sent to obtain a possibly modified copy and depending on the request the current owner downgrades to exclusive, shared, or invalid state. If the RDIR indicates a shared state for a requested line of cache, then a snoop request must be sent to invalidate the current owner(s) if the original request is for exclusive. In this case, the local caching agents may also have shared copies so a snoop is also sent to the local agents to invalidate the cache line. If an RDIR indicates that the requested line of cache is invalid, then a snoop request must be sent to local agents to obtain a modified copy if the cache line exists locally and/or downgrade the current owner(s) as required by the request. In an alternate embodiment, the requesting agent can perform this retrieve and downgrade function locally using a broadcast snoop function.

If a line of cache is checked out to another cell, the requesting cell can inquire about its status via the interconnection between the cells. In one embodiment, this interconnection is via a high speed serial virtual channel link with a specific protocol termed Unisys® Scalability Protocol (USP). This protocol defines a set of request and associated response messages that are transmitted between cells to allow one cell to interrogate another cell as to the status of a cache line.

In FIG. 1d, the IHA 340 of cell X 310 can request cache line status information of cell Y 360 by requesting the information from ICA (394) via communication link 356. Likewise, the IHA 390 of cell Y 360 can request cache line status information of cell X 310 by requesting the information from ICA 342 via communication links 355. The IHA acts as the intermediate home agent to socket 0 130a when the home of the request is not in socket 0 130a (i.e. the home is in a remote cell). From a global view point, the ICA of the cell that contains the home of the request is the global home and the IHA is viewed as the global requester. Therefore the IHA issues a request to the home ICA to obtain the desired cache line. The ICA has an RDIR that contains the status of the desired cache line. Depending on the status of the cache line and the type of request the ICA issues global requests to global owners (IHAs) and may issue the request to the local home. Here the ICA acts as a local caching agent that is making a request. The local home will respond to the ICA with data; the global caching agents (IHAs) issue snoop requests to their local cell domain. The snoop responses are collected and consolidated to a single snoop response which is then sent to the requesting IHA. The requesting agent collects all the (snoop and original) responses, consolidates them (including its local responses) and generates a response to its local requesting agent. Another function of the IHA is to receive global snoop requests, issue local snoop requests, collect local snoop responses, consolidate them, and issue a global snoop response to global requester.

The intermediate home and cache agents of the coherency director allow the upward scalability of the basic multiprocessor sockets to a system of multiple cells as in FIG. 1b or d. Applying aspects of the current invention allows multiple instances of the multiprocessor system assembly to be interconnected and share in a cache coherency system. In FIG. 1d, intermediate home agents (IHAs) and intermediate cache agents (ICAs) act as intermediaries between cells to arbitrate the use of shared cache lines. System controllers 345 and 395 control logic and sequence events within cell X 310 and cell Y 360 respectively.

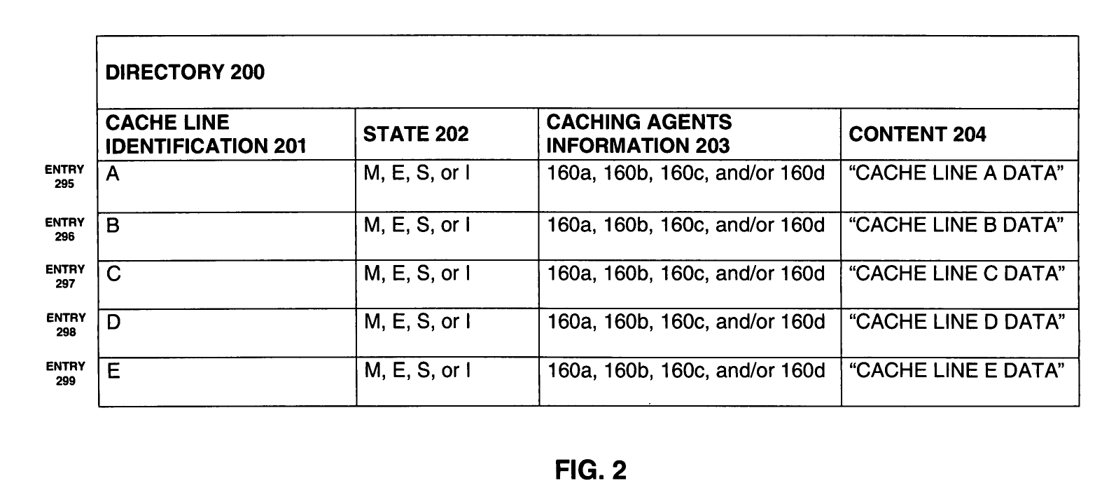

An example directory is shown in FIG. 2. Each entry of the directory 200 represents a cache line. In the example shown, each entry may include a cache line identification 201, a state 202, and information identifying the caching agents 160a-d accessing the particular line (caching agents information 203). The content 204, which may be part of each cache line entry of the directory 200, represents the cache line's data. The information 201, 202, 203, and 204 may be represented in a variety of manners, and the invention is not limited to any particular identification scheme. The invention is not limited to information 201, 202, 203, and 204, and it is contemplated that other information may be included for each entry.

The directory 200 as shown in FIG. 2 includes five example entries, entry 295, 296, 297, 298, and 299 for cache lines A, B, C, D, and E, respectively. The state 202 of each cache line may be one of modified (M), exclusive (E), shared (S), or invalid (I), as discussed in more detail above with relation to the multi-cell system 100 of FIG. 1. The caching agents 160a-d accessing the cache lines may be caching agents 160a-160d from the system 100. The system may also include other caching agents.

An age and usage of each cache line may indicate the amount of time the particular caching agent 160a-d has been included in the directory 200 and may be determined by the position of the entry of the caching agent 160a-d in the directory 200. The age and usage may be determined by the position of an entry at a congruence class. The oldest entry may be the left most entry or the least recently used (LRU) entry. The newest entry may be the right most entry (MSU).

An algorithm for updating the directory 200 may include selecting an entry of the congruence class to evict. The selection of the victim entry may be prioritized first by an unused or “I” entry, followed by the oldest entry (LRU entry). If the evicted entry is not I or unused and is not equal to the new entry, then the entry may be invalidated at the current owners by issuing snoop requests. The entries of the congruence class may then be left shifted such that all the entries to the right of the victim entry are shifted left. This eliminates the victim and opens a new entry position on the right end of the directory 200. Then the new entry (the MRU entry) is inserted into the right end of the directory 200.

In an embodiment, an age field may be included in the directory 200. The age field may indicate the time from the last access as seen by the directory 200. The age field may be included with each entry, serving as an indication of the age of the entry in terms of the elapsed time that the congruence class was last sampled for a patrol scrubbing or preemptive eviction, for example. The age field may be kept as small as possible so that a large number of bits are not required for its identification. The age field of a cache line may be initialized to zero when it is updated. The age fields of every entry in a congruence class are incremented each time the congruence class is sampled for preemptive eviction processing. If the increment of an entry causes the most significant bit (overflows) of the counter to set, then subsequent increments will not reset that bit. When the preemptive eviction processing is performed, the age fields of the oldest (left most) entry or entries are compared to a programmable age limit register. If the age field exceeds the limit register, then the entry is a candidate for preemptive eviction (together with the other criteria).

The content 204 of the lines of cache may include a congruence class. Each congruence class may include ways. The physical address may, for example, be divided into the following three fields:

Addr(5:0)=Byte address within a cache line (64 Byte cache line);

Addr(n:6)=congruence class, the lower bits from bit (n) to bit 6; and

Addr(m:n+1)=tag (cache line identification) from the most significant address bit to the congruence class.

The directory 200 may be set associative where the directory 200 is addressed by the congruence class to read the entry. The entry may contains ways, where each way is a cache line entry. The current state of a cache line may be determined by comparing the tag of the requested cache line to the tags of the entries at the congruence class. If a match is found, then the corresponding state and owners may have been determined. If no match is found then the “I” state may be implied.

In a sparse directory, as there are a limited number of locations in which to store cache line entries, when a new cache line entry needs to be included in the directory 200, an existing cache line entry may need to be removed, or evicted, from the directory 200 in order to accommodate and provide space for the new entry. A new entry may be created when a line of cache is now being accessed by one or more caching agents 160a-d, for example. Or a new entry may be created when the state of a line of cache has changed. This last case can be thought of as a deletion of the current cache line and the addition of the new cache line with a new state and the same address.

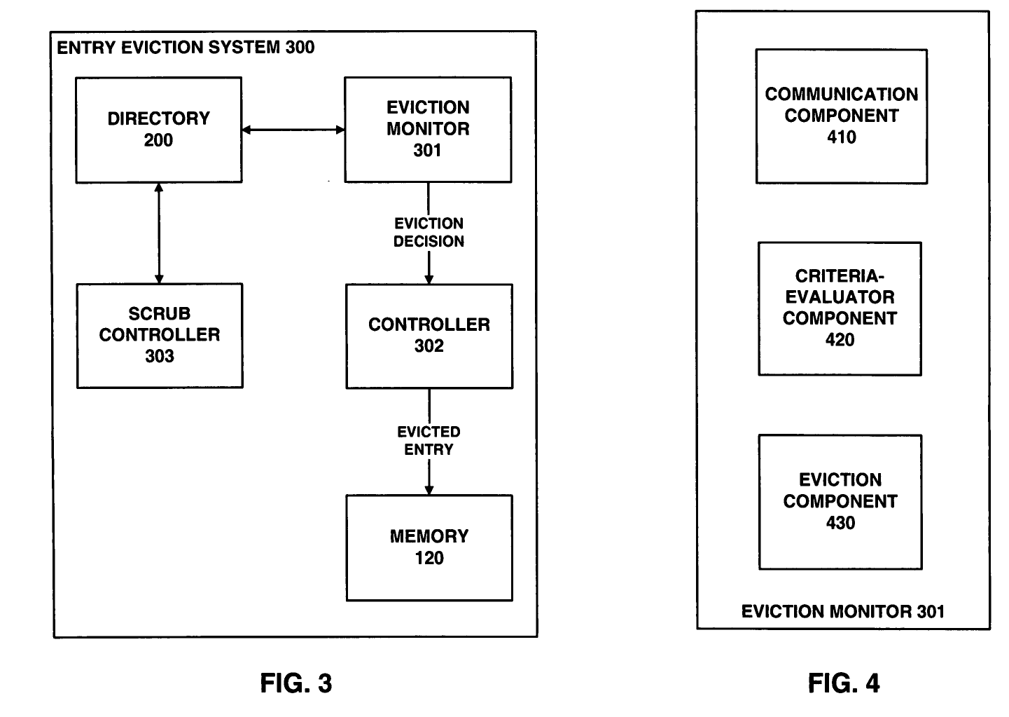

According to an embodiment, a system 300 to perform an entry eviction from a directory, such as the directory 200, may include an eviction monitor 301 that selects an entry, which may be a cache line entry, from the directory 200 for eviction and a controller 302 that, upon receipt of an eviction decision from the eviction monitor, performs the eviction from the directory. An example of such a system (an entry eviction system 300) is illustrated in FIG. 3. A directory 200 may store cache line entries, as discussed above, that may include various pieces of information relating to the entries. An entry may identify, for example, the state 202 of the cache line, as well as the caching agents, if any, accessing the cache line. Other information may also be included in the directory entries.

In order to create space in the directory 200 for a new cache line entry, an eviction monitor 301 may communicate with the directory 200 in order to select an entry for eviction from the directory 200. Once the eviction monitor 301 identifies an entry for eviction, the eviction monitor 301 may notify a controller 302 of the entry eviction choice. The controller 302 may then perform the eviction of the entry.

The entry for eviction may be selected by the eviction monitor 301 and evicted from the directory 200 by the controller 302 when the system 100 is running in an idle or low-activity state. In such a state, the system 100 may not be consuming a large quantity of system resources, allowing the eviction to proceed with minimal interruption or slowness to the system. Additionally, the system 100 being in at least a low-activity state for eviction allows space in the directory 200 to be created before a new entry must wait for space to be made. Thus, there is minimal waiting time for the new entry's inclusion into the directory 200.

The eviction monitor may increment a congruence class counter that is used to access the sparse directory. The entry for eviction may be determined by the number of unused ways in an entry. If the number of unused ways is less than a programmer parameter set during initialization, then the LRU entry may be a candidate for eviction. This candidate may not be evicted if an entry cannot be made in a coherency tracker, which is used to track coherent requests in progress. However, this may not often occur since the eviction monitor 301 may one only activated when there is low request activity. Additionally, if the coherency tracker is currently servicing a request for the same cache line, then the entry is evicted but the current owners do not need to be invalidated. In this case, the conflicting request will make a new entry into the directory 200 when it completes. In addition, the congruence class may include ways, and if the ways of an entry are utilized, that entry may be chosen to be evicted.

If the ways of a congruence class of an entry are utilized, other considerations may be applied in determining if an entry should be evicted from the directory 200. For example, one such consideration may be if the content 204 of the entry meets a predetermined criteria, then the eviction monitor 301 may select that entry for eviction. For example, if the content 204 of the entry is the least-recently used entry of the directory, the entry may be selected for eviction. This may be determined by the eviction monitor 301 with reference to the age or usage positioning of the entries of the directory 200. Or an entry may be selected for eviction if the entry's content includes a least-recently used entry of a specified state of cache (currently determined by position), for example the modified state of cache (determined by the state field), as described in more detail above. Another predetermined criteria may be the oldest entry of the directory 200, which may be determined through a consultation with the directory 200, for example consulting the age field information of the directory 200. Other criteria are also possible.

Criteria for eviction selection by the eviction monitor 301 may include two conditions to allow for the possibility that more than one entry may meet a single criterion. For example with reference to the directory 200 of FIG. 2, entries 296 and 297 may have the same age and be the oldest entries of the directory 200. Both entries 296 and 297 may be evicted from the directory, or the eviction determination, made by the eviction monitor 301, may consider a second factor, such as the state 202.

An entry chosen for eviction, for example the oldest entry of the directory 200 whose congruence class is utilized, may not necessarily be evicted upon selection by the eviction monitor 301. Instead, the controller 302 may wait a predetermined amount of time before performing the eviction. Or the eviction monitor 301 may wait a predetermined amount of time before transferring the eviction decision to the controller 302. Alternatively, the eviction monitor 301 may reexamine the contents of the entries of the directory 200 before performing the eviction.

The eviction of the entry may include the elimination of the entry from the directory 200. The eviction may also include transferring the entry to a memory location, such as the memory 120, which may be a centralized or distributed memory. The controller 302 may perform the entry-to-memory transfer. This transfer allows for the entry to remain available if, for example, a cell, such as cell 110a-d of system 100, later desires access to the entry. Modified (M) and/or exclusive (E) entries that have been modified by a caching agent 160a-d may be updated in memory 120 before eviction from the directory 200.

The entry eviction system 300 that performs the entry eviction may also include a scrub controller 303. The scrub controller 303 performs a protection mechanism by checking the contents of the directory 200 for errors. If an error is discovered, the scrub controller 303 may correct the error by, for example, cleaning, or eliminating and/or altering, the content so that the error is removed. The scrub controller 303 may check the contents of the directory 200 by examining the congruence classes and the ways of the entries. The scrub controller 303 may, in the same manner as the eviction controller 302, access the directory 200 via the congruence counter and may, therefore, be used to perform both scrubbing and preemptive eviction operations.

FIG. 4 is a block diagram of an eviction monitor 301 according to an embodiment of the invention. The eviction monitor 301 includes several means, devices, software, and/or hardware for performing functions, including a communication component 410, a criteria-evaluator component 420, and an eviction component 430, which operate to select and evict an entry from the directory 200 for a preemptive eviction mechanism.

The communication component 410 may be responsible for communicating with the directory 200 to determine entries available for eviction. The communication may include consultation with the content 204 field of the directory 200, in order to determine an entry that includes a utilized congruence class. The communication component 410 may also perform communication tasks between the eviction monitor 301 and the directory 200 in order to determine if an entry, that includes a congruence class, also includes ways that are utilized.

The criteria-evaluator component 420 may evaluate predetermined criteria to determine if the content (i.e., the entry) may be evicted. The criteria-evaluator component 420, for example, may compare the content 204 of the entry with criteria, such as least-recently used and oldest entries. If the predetermined criteria establishes that the entry for eviction be the oldest entry of the directory 200, then the criteria-evaluator component 420 may ascertain the age of the entries of the directory 200 to determine if an entry meets this criteria. If the entry does not meet the requirement, the entry is not chosen for eviction. Then, another entry whose congruence class is utilized may be evaluated to determine if that particular entry meets the criteria. Criteria for eviction selection by the criteria-evaluator component 420 of the eviction monitor 301 may include two conditions to allow for the possibility that more than one entry may meet a single criterion. For example two entries may have fully-utilized congruence classes. If the predetermined criteria indicates that the least-recently used entry be evicted, then the least-recently used entry of the two entries will be selected for eviction upon appropriate determination by the criteria-evaluator component 420.

If the entry meets the predetermined criteria as evaluated by the criteria-evaluator component 420, then the eviction component 430 of the eviction monitor 301 may perform the actual eviction of the selected entry. The eviction may include deleting the entry from the directory 200 and may also include transferring the evicted entry to a memory location, such as the memory 120.

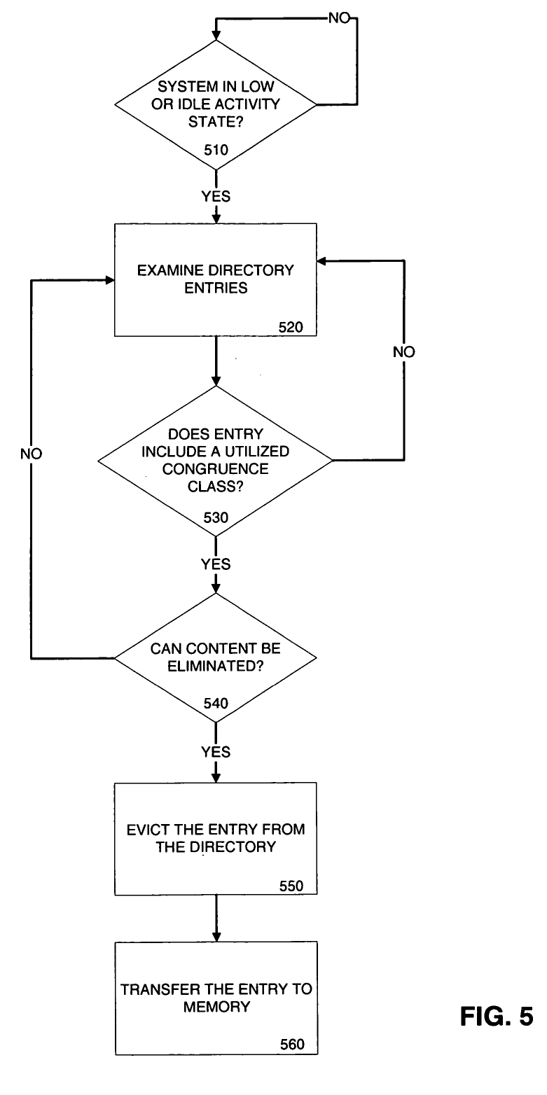

A preemptive eviction method is described with respect to the flow diagram of FIG. 5. At step 510 a decision is made in order to determine if a system, such as the system 100, is in a low or idle activity state. If the system is in a low or idle activity state, then the eviction may occur without interrupting or slowing the system and without forcing a new entry to wait for space to be created in the directory 200. If the system is not in a low or idle activity state, then the preemptive eviction method may not proceed until the system is in such a state.

At step 520, after it has been determined that the system is in a low or idle activity state, entries of the directory 200 are examined. For example with reference to FIG. 2, each of the entries 295, 296, 297, 298, and 299 may be examined. Then at step 530, the method includes determining if an entry includes a utilized congruence class, which is the criteria for evicting a cache line. If the entry does not include a utilized congruence class, then the method returns to step 520, in order to examine other entries of the directory 200. If, however, an entry does include a utilized congruence class, the method may proceed to step 540.

At step 540, a decision to eliminate the content is performed. If the content may be eliminated, the method may proceed to step 550. If the content cannot be eliminated, then the method proceeds from step 540 back to step 520, in order that other entries of the directory 200 be examined.

At step 550, the selected entry is evicted from the directory. The eviction may be performed by the controller 302 upon receipt of an eviction decision from the eviction monitor 301. At step 560, after the entry has been evicted from the directory 200, the entry may be transferred to memory, such as memory 120. The controller 302 of the entry eviction system 300 may be responsible for the memory transfer. Associated with the eviction may be a requirement to send snoop requests to invalidate the cache line from the current owners. If the state of the directory 200 is exclusive (E) or modified (M), then the current owner may respond with data if it is modified. Memory 120 may be updated with this modified data.

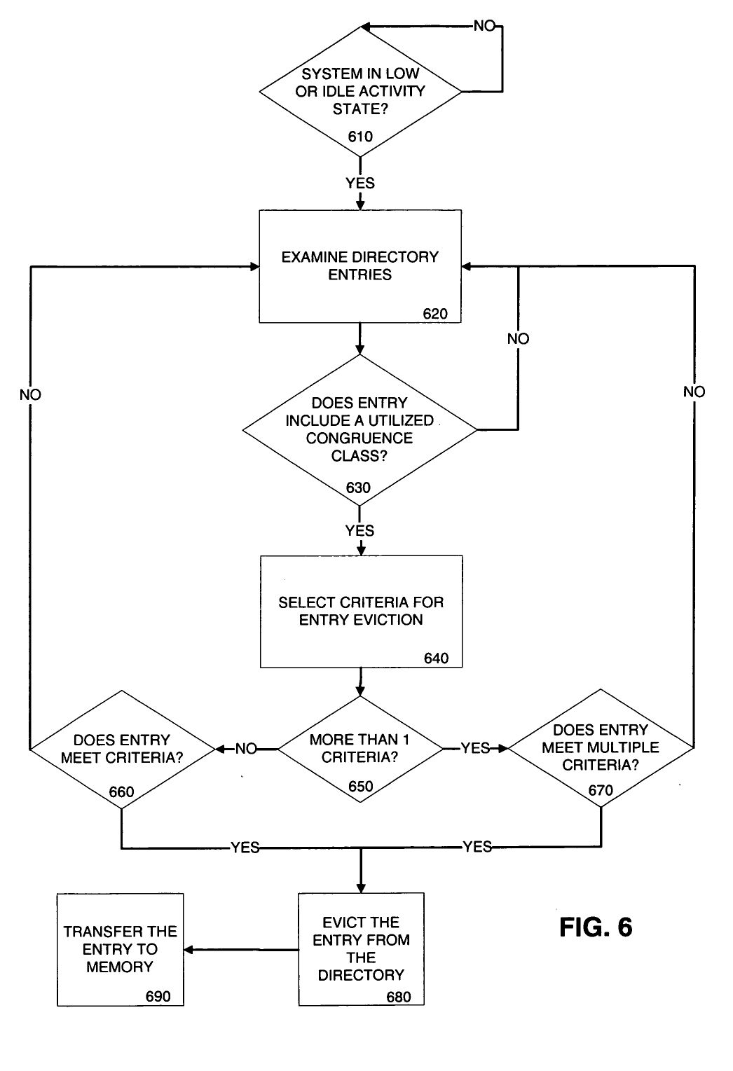

A preemptive eviction method according to another embodiment is described with respect to the flow diagram of FIG. 6. At step 610, similar to the method shown in FIG. 5, a decision is made in order to determine if a system, such as the system 100, is in a low or idle activity state. If the system is not in a low or idle activity state, then the preemptive eviction method may not proceed until the system is in such a state.

At step 620, after it has been determined that the system is in a low or idle activity state, entries of the directory 200 are examined. Then at step 630, the method includes determining if an entry includes a utilized congruence class. If the entry does not include a utilized congruence class, then the method returns to step 620, in order to examine other entries of the directory 200. If, however, an entry does include a utilized congruence class, the method may proceed to step 640.

At step 640, criteria for entry eviction are obtained. Such criteria may include that the entry be the least used entry of the directory 200. Other entry eviction criteria are also possible. At step 650, a determination is made as to whether more than one criteria has been selected. If there is just one criteria for entry eviction, the method proceeds to step 660, where it is determined if the selected entry meets the criteria. If multiple criteria for entry eviction exist, then the preemptive eviction method proceeds from step 650 to step 670. At step 670, it is determined if the chosen entry satisfies all of the criteria.

If step 660 or step 670 indicate that the entry does not meet the selected criteria, then the method proceeds back to step 620 to examine other directory entries. If the criteria are met, then the method proceeds to step 680. At step 680, the entry chosen for eviction and satisfying any selected eviction criteria is evicted from the directory 200. At step 690, after being evicted from the directory, the modified data associated with the evicted entry may be transferred to memory 120.

As mentioned above, while exemplary embodiments of the invention have been described in connection with various computing devices, the underlying concepts may be applied to any computing device or system in which it is desirable to implement a multiprocessor cache system. Thus, the methods and systems of the present invention may be applied to a variety of applications and devices. While exemplary names and examples are chosen herein as representative of various choices, these names and examples are not intended to be limiting. One of ordinary skill in the art will appreciate that there are numerous ways of providing hardware and software implementations that achieves the same, similar or equivalent systems and methods achieved by the invention.

As is apparent from the above, all or portions of the various systems, methods, and aspects of the present invention may be embodied in hardware, software, or a combination of both.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims.

What is claimed:

1. A method of entry eviction in a directory, the method comprising:
determining whether an entry of the directory comprises a congruence class that is utilized; and
if the entry comprises a congruence class that is utilized, then determining if the content of the congruence class can be eliminated.

2. The method of claim 1, further comprising:
if the content of the congruence class can be eliminated, then evicting the entry.

3. The method of claim 2, wherein evicting the entry comprises eliminating the entry from the directory.

4. The method of claim 3, further comprising:
transferring modified data associated with the entry to a memory location.

5. The method of claim 1, further comprising:
determining if a system utilizing the directory is in an idle or a low-activity state;
wherein the step of determining whether an entry of the directory comprises a congruence class that is utilized comprises if the system is in an idle or a low-activity state, then determining whether an entry of the directory comprises a congruence class that is utilized.

6. The method of claim 1, further comprising:
performing a scrubbing of entries of the directory.

7. The method of claim 1, wherein determining if the content of the congruence class can be eliminated comprises determining if the content of the congruence class meets a predetermined criteria.

8. The method of claim 7, wherein determining if the content of the congruence class meets a predetermined criteria comprises determining if the content comprises a least-recently used entry.

9. The method of claim 7, wherein determining if the content of the congruence class meets a predetermined criteria comprises determining if the content comprises an oldest entry of the directory.

10. A system for evicting an entry from a directory, the system comprising:
a directory comprised of entries;
an eviction monitor that selects an entry from the directory for eviction; and
a controller that receives eviction decisions from the eviction monitor and performs the eviction.

11. The system of claim 10, further comprising:
a scrub controller.

12. The system of claim 10, wherein the eviction monitor selects an entry for eviction if the system is in an idle or a low-activity state.

13. The system of claim 10, wherein the eviction monitor selects an entry for eviction based on a predetermined criteria.

14. The system of claim 13, wherein the predetermined criteria is a least-recently used entry.

15. The system of claim 13, wherein the predetermined criteria is an oldest entry of the directory.

16. A method of entry eviction in a sparse directory, the method comprising:
determining if a system utilizing the sparse directory is in an idle or a low-activity state;
determining whether an entry of the sparse directory comprises a congruence class that is utilized;
if the entry comprises a congruence class that is utilized, then determining if the content of the congruence class can be eliminated; and
if the content of the congruence class can be eliminated, then evicting the entry from the sparse directory.

17. The method of claim 16, further comprising:
transferring the entry to a memory location.

18. The method of claim 16, wherein if the content of the congruence class can be eliminated, then evicting the entry from the sparse directory comprises waiting a predetermined period of time before evicting the entry.

19. The method of claim 16, wherein determining if the content of the congruence class can be eliminated comprises determining if the content of the congruence class meets a predetermined criteria.

20. The method of claim 16, further comprising wherein determining if a system utilizing the sparse directory is in an idle or a low-activity state comprises determining an amount of system resources consumed by the system.
